(19) United States
(12) Patent Application Publication
(10) Pub. No.: US 2008/0066097 A1
(43) Pub. Date: Mar. 13, 2008

(54) Method Of Realizing Interactive Advertisement Under Digital Braodcasting Environment By Extending Program Associated Data-Broadcasting To Internet Area

(76) Inventors: Woodhyun Park, Gwangju (KR); Dongho Choi, Gwangju (KR)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/575,975

(22) PCT Filed: Oct. 12, 2005
(86) PCT No.: PCT/KR05/03400

§ 371 Date: Jun. 4, 2007

(30) Foreign Application Priority Data
Oct. 13, 2004 (KR) 10-2004-0081867

(51) Int. Cl. H04N 7/10

(52) U.S. Cl. 725/32

(57) ABSTRACT

Disclosed is a method for providing an interactive advertisement and detailed information, which including: (a) converting a secondary information tag, which is used for calling secondary information relating to data broadcasting, into data broadcasting contents according to data broadcasting protocols? (b) inserting the secondary information tag converted in step (a) into a data broadcasting area of a digital broadcasting stream; (c) transmitting the digital broadcasting stream including the secondary information tag, thereby allowing the digital broadcasting stream to be received in a digital broadcast receiver or a personal computer; and (d) when a request for the secondary information is received from the digital broadcast receiver or the personal computer, transmitting the secondary information from a secondary information server to the digital broadcast receiver or the personal computer connected to a communication network.

### TECHNICAL FIELD

The present invention relates to a method for providing an interactive advertisement and detailed information (hereinafter, referred to as secondary information), and a construction of a broadcasting system using the same. More particularly, the present invention relates to a method for providing secondary information and a broadcasting system using the same, in which a designator (icon) marked by a symbolized picture or sign, which reports existence of secondary information, i.e. data broadcasting information, is provided on an initial screen (broadcasting screen) of a digital broadcast receiver, the initial screen changes to a primary screen when a viewer has selected the designator, the primary screen changes to a secondary screen through a selection of a designator on the primary screen, and secondary information is provided from a server connected to an associated communication network to the digital broadcast receiver when the viewer calls the secondary information.

### BACKGROUND ART

Data broadcasting transmits not only information data including characters, numbers, diagrams, charts and images, but also video, voice and sound based on the information data and broadcasting programs including combinations of the video, voice and sound through channels of a broadcaster. Data broadcasting may be classified into program-associated data broadcasting or enhanced data broadcasting and stand-alone data broadcasting.

A term “initial screen” represents a screen on which a corresponding television broadcasting program is displayed, a “primary screen” represents an early screen moved from the “initial screen” through a connection (a designator selection), and a “secondary screen” represents a screen moved from the “primary screen” through a connection. A “designator” represents not only a picture or a sign on the initial screen but also an icon or a selection for providing a hyperlink with secondary information on a screen displayed in connection with the primary screen, the secondary screen, etc.

In the case of a conventional analog television advertisement, an interactive service or an Internet search service between a broadcaster and a viewer has not yet been provided due to technical limitations of analog broadcasting. Further, although a data service has been provided by means of several scanning lines in a Vertical Blanking Interval (hereinafter, referred to as VBI), only a small quantity of character information has been provided and Internet data search using a telephone line modem has also not been activated.

In such analog broadcasting environment, a viewer receives broadcasting signals transmitted in one direction by a broadcaster, and watches broadcasting programs or advertisements on an initial screen. That is, a broadcasting advertisement according to the prior art has been displayed to a viewer during a short time period of about 20 seconds during which an advertisement is broadcasted.

In digital broadcasting, a broadcaster can no longer use the VBI of an image as a channel for providing supplementary information. This is because most data of the VBI are ignored in a final transmission step of broadcasting, i.e. in the process of encoding the image.

A digital broadcast receiver typically includes a communication modem or a Network Interface Card (hereinafter, referred to as NIC) for enabling access to a communication network. Therefore, Internet access using the communication modem or the NIC has been attempted, but that is only a simple level of receiving programs necessary for the receiver, files for a game, or data.

Further, information of an Internet server has been searched, but it uses a method of replacing data broadcasting middleware simultaneously executed when a receiver is powered with TCP/IP-based middleware, and executing a search using an Internet search browser. Therefore, the data broadcasting middleware in the general receiver has not been efficiently utilized. This may increase the probability of a serious system error and requires a long program update time period.

In the meantime, since a data broadcasting stream area as a hyperlink, through which a broadcaster provides supplementary information to a viewer, has a very small transmission capacity of less than 1 Mbps, it is difficult to provide the viewer with various multimedia information in a Windows environment.

However, since a backbone channel connected to the NIC of a receiver is connected to a high speed wire or wireless network, such as an ultra high speed communication network or a broadband communication network, it is possible to provide a viewer with higher transmission capacity, so that the limitations of a data broadcasting stream area can be overcome. Further, data broadcasting protocols of all countries of the world described in FIG. 11 have defined a layer structure for retrieving, describing and expressing information, and have provided tools for interactive information exchange.

### DISCLOSURE OF THE INVENTION

Therefore, the present invention has been made in view of the above-mentioned problems, and an object of the present invention is to provide an interactive communication method for inserting an Uniform Resource Locator (hereinafter, referred to as URL) used for searching secondary information or detailed advertisements into data broadcasting contents in a broadcasting production step and/or a broadcasting transmission step, transmitting the data broadcasting contents, selecting a designator (icon) necessary when a viewer watching a broadcast searches for general data broadcasting, calling the URL, accessing to a remote server, and receiving a large quantity of information through a broadcast receiver via a wire ultra high speed communication network or broadband communication network, or a wireless communication network. That is, a first object of the present invention is to provide a method for extending program-associated data broadcasting to an Internet area under digital broadcasting environments and a system using the same. A viewer can experience the effect of the present invention by using a general broadcast receiver or a computer sold in markets.

A second object of the present invention is to increase the effect of broadcasting advertisements and program-associated data broadcasting in digital television broadcasting environments.

A third object of the present invention is to receive a URL of a server including secondary information or detailed advertisements on a communication network from an advertiser or a program producer in an authoring step, process the URL into data broadcasting contents, and transmit the data broadcasting contents.

According to one aspect of the present invention, there is provided a method for extending program-associated data broadcasting to an Internet area in digital broadcasting environments providing digital broadcasting, thereby providing interactive information, the method including the steps of: (a) converting a secondary information tag, which is used for calling secondary information relating to data broadcasting, into data broadcasting contents according to data broadcasting protocols; (b) inserting the secondary information tag converted in step (a) into a data broadcasting area of a digital broadcasting stream; (c) transmitting the digital broadcasting stream including the secondary information tag, thereby allowing the digital broadcasting stream to be received in a digital broadcast receiver or a personal computer; and (d) when a request for the secondary information is received from the digital broadcast receiver or the personal computer, transmitting the secondary information from a secondary information server to the digital broadcast receiver or the personal computer connected to a communication network.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram illustrating all processes for receiving a secondary information tag, which includes related information such as the URL of a secondary information server, from an advertiser or a program producer in data broadcasting authoring step, and processing the tag into program-associated data broadcasting contents for transmission according to the present invention;

FIG. 2 is a diagram illustrating an ancillary data area of component digital broadcasting signals according to the present invention;

FIG. 3 is a block diagram illustrating the constructions of a secondary information tag input unit and a secondary information tag inserter according to the present invention;

FIG. 4 is a block diagram illustrating the constructions of a secondary information tag extractor and a secondary information tag processing unit according to the present invention;

FIG. 5 is a flow diagram illustrating a process for processing and authoring a secondary information tag as data broadcasting contents;

FIG. 6 is a diagram illustrating the structure of designators and menus to be displayed in an image output unit (monitor) according to the present invention;

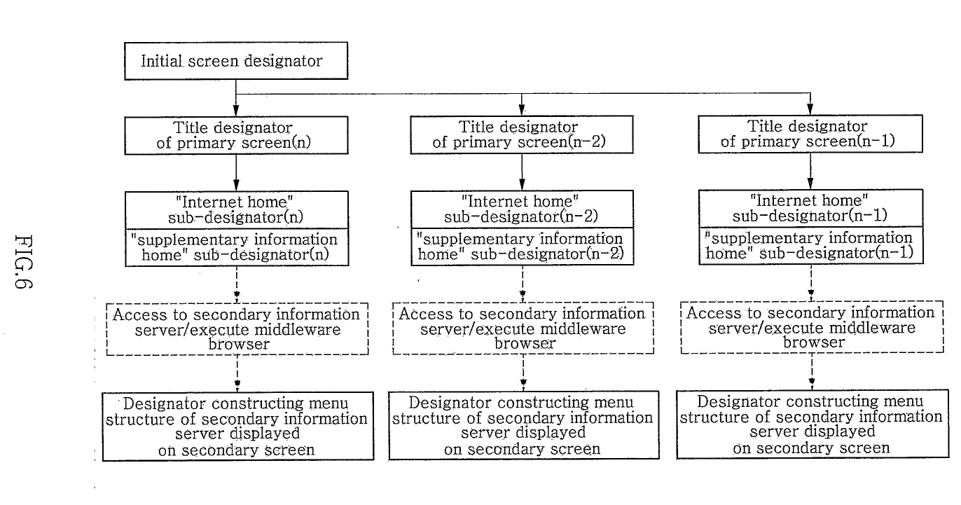

FIGS. 7a to 7c are diagrams illustrating an initial screen, a primary screen, a secondary screen, and a designator according to a preferred embodiment of the present invention;

FIG. 8 is a flow diagram illustrating a process in which a viewer searches for secondary information according to the present invention;

FIG. 9 is a block diagram illustrating the general construction of a digital broadcast receiver sold in markets, and a process for searching and processing secondary information;

FIG. 10 is a block diagram illustrating a remote control to which the present invention is applied; and

FIG. 11 is a diagram illustrating correlation among data broadcasting protocols to which the present invention can be applied.

### BEST MODE FOR CARRYING OUT THE INVENTION

Reference will now be made in detail to the preferred embodiment of the present invention. The same reference numerals are used to designate the same elements as those shown in other drawings. In the following description of the present invention, a detailed description of known configurations and functions incorporated herein will be omitted when it may make the subject matter of the present invention rather unclear.

A description will be given on an assumption that digital broadcasting is received through a set-top box, which is a digital TV receiver, or a personal computer having an Internet browser. However, the present invention is not limited to this. Also in a case in which mobile multimedia broadcasting, digital audio broadcasting or digital radio broadcasting is received through a mobile portable phone, etc., the present invention can be extended and used in the same way.

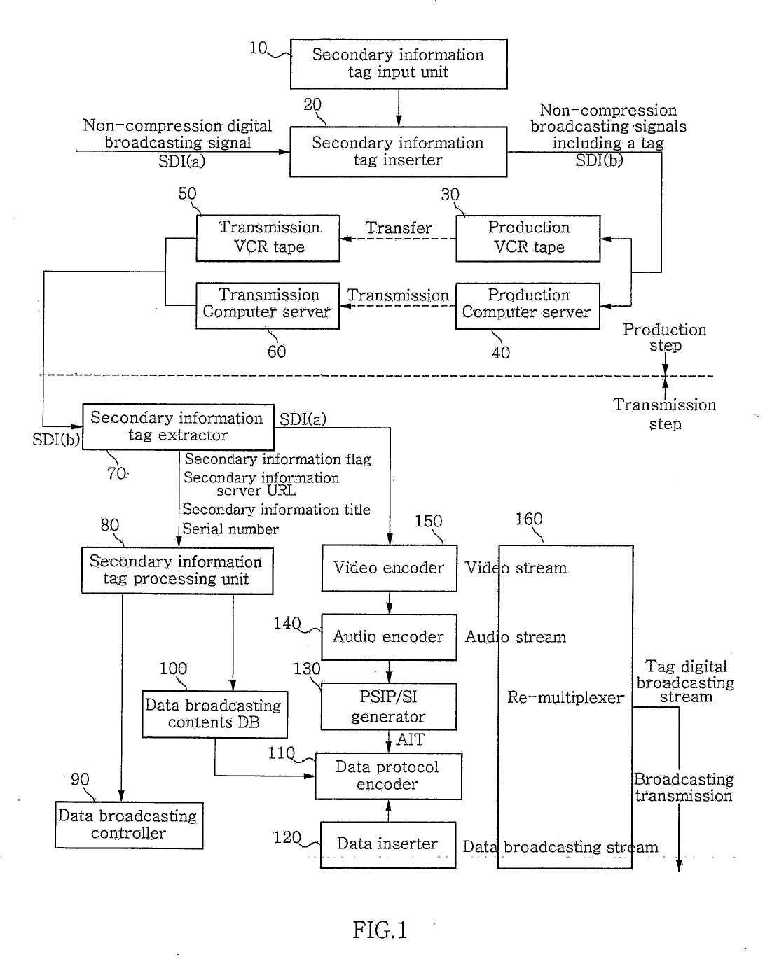

FIG. 1 is a block diagram illustrating all processes for receiving a secondary information tag from an advertiser or a program producer in data broadcasting contents authoring step, and processing the tag into program-associated data broadcasting contents for transmission according to the present invention. Referring to FIG. 1, the secondary information tag is inputted to non-compression Serial Digital Interface (hereinafter, referred to as SDI) signals in a broadcasting program or broadcasting advertisement production step by using a secondary information tag input unit 10 and a secondary information tag inserter 20. The secondary information tag includes a secondary information flag, a Uniform Resource Locator (hereinafter, referred to as URL) of a secondary information server, a secondary information title, and a serial number.

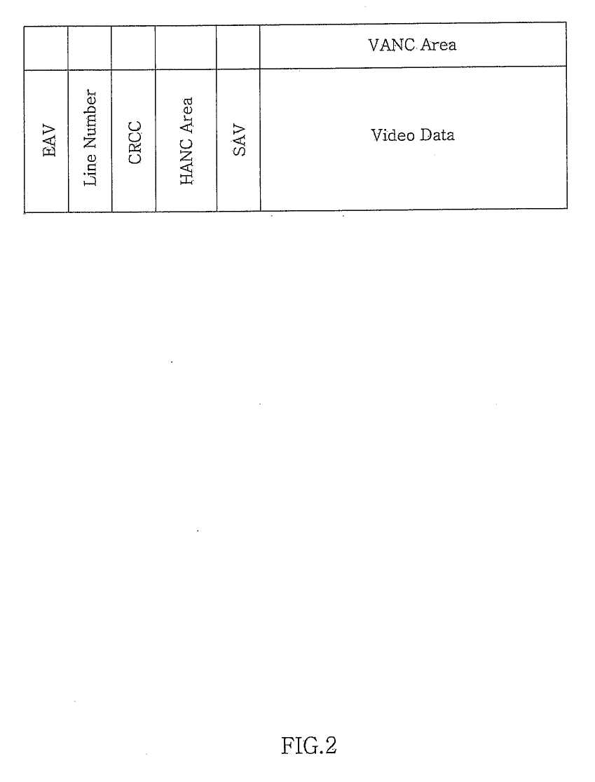

In a preferred embodiment of the present invention, a location at which the secondary information tag is inserted into the SDI signals corresponds to a Horizontal Ancillary (hereinafter, referred to as HANC) data area or a Vertical Ancillary (hereinafter, referred to as VANC) data area as illustrated in FIG. 2. Referring to FIG. 2, excepting for a synchronization word including an End of Active Video (EAV) and a Start of Active Video (SAV), etc., the HANC using a Horizontal Blanking Interval (HBI) and the VANC using a Vertical Blanking Interval (VBI) correspond to an ancillary data area, respectively. In the preferred embodiment of the present invention, the secondary information tag may be inserted into the ancillary data area as described above.

The SDI signals according to the present invention correspond to component digital signals of a standard definition and a high definition, which have a detailed standard as shown in table 1 below.

TABLE 1

| Types of | Serial data | | |
|---|---|---|---|
| baseband | transmission | | |
| signals | rate | Sampling rate | Standard |
| SDI Component | 270 Mbps | Y: 13.5 MHz | SMPTE 259 M/C |
| 525i 4:3 | | Cr, Cb: 6.75 MHz | |
| SDI Component | 360 Mbps | Y: 18 MHz | SMPTE 259 M/D |
| 525i 16:9 | | Cr, Cb: 9 MHz | |
| HD-SDI@ | 1.483516 Gbps | Y: 74.1758 MHz | SMPTE292M |
| 23.976/29.97 | | Cr, Cb: | |
| frame rates | | 37.0879 MHz | |
| HD-SDI@ | 1.485 Gbps | Y: 74.25 MHz | SMPTE292M |
| 24/25/30 | | Cr, Cb: | |
| frame rates | | 37.125 MHz | |

In the meantime, information inputted through the secondary information tag input unit 10 is inserted into serial digital broadcasting signals SDI(a) through the secondary information tag inserter 20. Non-compression signals SDI(b) including a tag are recorded on a VCR tape 30 or recorded in a computer server 40, and are transferred or transmitted to predetermined units for transmission through a transport network or a network.

Files stored in a VCR tape 50 or a computer server 60 are sent to a secondary information tag extractor 70. The secondary information tag extractor 70 extracts the secondary information flag, the URL of a secondary information server, the secondary information title, the serial number, etc., and sends the resultants from the extraction to a secondary information tag processing unit 80. The secondary information tag processing-unit 80 authors a secondary information tag as data broadcasting contents. The authored secondary information tag is carried to a data broadcasting controller 90 and a data broadcasting database 100. The secondary information tag processing unit 80 may directly receive the secondary information tag, or receive the secondary information tag from the secondary information tag extractor 70.

TABLE 2
<Item configuration of secondary information tag>

| Item name | Description |
|---|---|
| 2flag | secondary information flag |
| 2title | secondary information representative name |
| i_addr | Internet homepage address in secondary |
| | information server URL |
| d_addr | Supplementary information homepage address in |
| | secondary information server URL |
| Code | secondary information serial number |

In the secondary information tag according to the preferred embodiment of the present invention, table 2 shows the item configuration of the secondary information tag. The secondary information tag may include the secondary information flag, two types of the secondary information server URLs, the secondary information title, and the serial number.

In table 2, the secondary information flag is an identifier representing the existence or absence and configuration of the secondary information, which may be classified into four types of flags as shown in table 3 below according to the existence or absence and type of the secondary information server URL. When the secondary information flag is a “2flag(1)” representing the absence of all secondary information server URLS, a designator is not displayed. Only when Internet or supplementary information homepage address exists, a designator is displayed on an initial screen.

TABLE 3
<Classification of secondary information flag>

| | | |
|---|---|---|
| Classification of | | |
| secondary | | |
| information flag | Note | Description |

| | | | |
|---|---|---|---|
| 2flag(1) | 00 | absence of all | existence of |
| | | secondary | secondary |
| | | information server | information title |
| | | URLs | and serial number |
| 2flag(2) | 01 | existence of only | same as above |
| | | Internet homepage | |
| | | address | |
| 2flag(3) | 11 | existence of | same as above |
| | | Internet and | |
| | | supplementary | |
| | | information | |
| | | homepage addresses | |
| 2flag(4) | 00 | existence of only | same as above |
| | | supplementary | |
| | | information | |
| | | homepage address | |

A server (homepage) including content of the secondary information may be classified into a Hypertext Transfer protocol (HTTP)-based homepage permitting an access using a general computer and a homepage conforming to a data broadcasting standard. A browser of a dedicated data broadcast receiver may only search for homepages created according to the data broadcasting standard, and a Personal Computer (PC)-based receiver may easily use an Internet search browser such as Internet Explorer.

TABLE 4
<Classification of search browser and homepage
according to data broadcast receiver>

| Type of receiver | Search browser | Search target |
|---|---|---|
| dedicated | search browser | supplementary |
| broadcast receiver | according to data | information |
| (including DMB | broadcasting | homepage (acap://, |
| phone) | standards (acap, | ocap://, mhp://, |
| | ocap, mhp, etc.) | etc.)) |
| Computer including | Internet browser | Internet homepage |
| TV reception card | (http browser) | (http://) |

Accordingly, two types of secondary information server URLs must be provided, and a secondary information provider must provide two types of homepages so that all viewers can search the secondary information. The supplementary information homepage conforming to the data broadcasting standard must be coded according to data broadcasting standards of corresponding media

The secondary information title is a name representing the secondary information. In the case of an advertisement, the secondary information title corresponds to an advertisement name. In the case of additional secondary information, the secondary information title corresponds to a title considering a search. Specifically, the serial number is for inserting an advertisement serial number into a tag, and efficiently processing an advertisement edition work or a transmission work.

Referring to FIG. 1, the secondary information tag input unit 10 receives the secondary information tag, stores the secondary information tag in a storage unit for management, calls the secondary information tag if the situation requires, and sends the secondary information tag to an RS 232/422 port. Further, the secondary information tag input unit 10 may compile the items of table 2 into a database for management, group tags based on transmission time zones or programs as illustrated in table 5, and call the tags by the group. Further, the secondary information tag input unit 10 may individually call the tags. In table 5, the group name “0728” represents an advertisement of a Station Break (SB) time, beginning at 07:28 AM, and the group name “XX program” represents an advertisement of a specific program.

TABLE 5
<Example of grouped secondary information tags>

| Group name | Order | Elements of group |
|---|---|---|
| 0728 | 1 | code(n), 2title(cn), 2flag(1), null, |
| | | null |
| | 2 | code(m), 2title(cm), 2flag(3), |
| | | i_addr(cm), d_addr(cm) |
| | 3 | code(l), 2title(cl), 2flag(2), |
| | | i_addr(cl), null |
| | . | . |
| | . | . |
| | . | . |
| XX program | 1 | code(m), 2title(cm), 2flag(3), |
| | | i_addr(cm), d_addr(cm) |
| | 2 | code(o), 2title(co), 2flag(2), |
| | | i_addr(co), null |
| | 3 | code(p), 2title(cp), 2flag(4), null, |
| | | d_addr(cp) |
| | . | . |
| | . | . |
| | . | . |

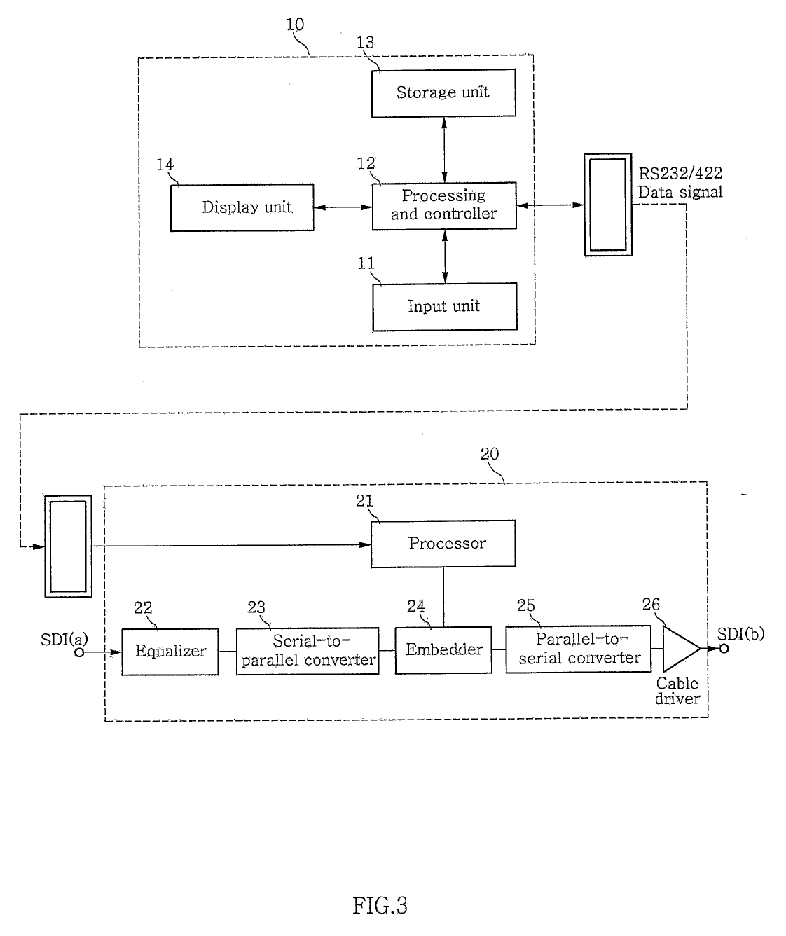

FIG. 3 is a block diagram illustrating the constructions of the secondary information tag input unit 10 and the secondary information tag inserter 20 according to the present invention. Referring to FIG. 3, the secondary information tag input unit 10 according to the present invention includes an input unit 11, a storage unit 13, a processing and controller 12 and a display unit 14, stores the inputted secondary information tag in the storage unit 13 for management, accesses the secondary information tag if the situation requires, and sends the secondary information tag to an RS 232/422 port.

Further, the secondary information tag input unit 10 may compile the items of table 2 into a database for management, group the tags based on transmission time zones or programs as illustrated in table 5, and call the tags by the group. Further, the secondary information tag input unit 10 may individually call the tags. Referring to FIG. 3, the secondary information tag inserter 20 according to the present invention includes an equalizer 22, a serial-to-parallel converter 23, an embedder 24, a parallel-to-serial converter 25, a processor 21 and a cable driver 26.

Inserting audio signals into an ancillary data area of SDI signals transferred through a coaxial cable is called “embedding” or “multiplexing”, and separating the audio signals from the SDI signals is called “de-embedding” or “de-multiplexing”. Since broadcasting, material is transferred from a production place to a transmission place in the form of a tape, or is transmitted through a communication network, the present invention proposes a method for inserting the secondary information tag into material like the audio signals embedded in the ancillary data area, and transferring the inserted secondary information tag.

The afore-mentioned secondary information tag passes through two steps before being inserted into the SDI signals like voice data. In the first step, secondary information tag information is converted by a serial digital audio signal standard AES3. A SMPTE 337M standard prescribes conversion of general data by the serial digital audio signal standard AES3. The processor 21 converts the tag information into AES3 signals according to the SMPTE 337M standard.

In the second step, the AES3 signals are inserted into the SDI signals. The secondary information tag information converted into the AES3 signals is embedded in the ancillary data area of the SDI signals according to a SMPTE 272M standard and a SMPTE 299M standard. The SMPTE 272M standard represents an embedding standard for SDI signals of a standard definition, and the SMPTE 299M standard represents an embedding standard for SDI signals of a high definition. Herein, a user may select an insertion location, i.e. a group ID and an audio channel number. In FIG. 3, the equalizer 22 compensates for the amplitude of input signals.

The produced broadcasting material are transferred or transmitted through a communication network according to its characteristics. Advertisement material may be transferred to a broadcasting station in the form of a tape through an advertisement agency, or may also be compiled into a computer file and transmitted through a communication network. In each case, the secondary information tag embedded in the ancillary data area is transferred to the secondary information tag processing unit, i.e. the authoring step of data broadcasting contents, so that the transfer process of the tag can be automated.

The material for which the final edition is completed in a broadcasting station is transferred in the form of a tape, or transferred to transmission equipments through a high speed communication network (multimedia data transport network) within the company. If a separate idle audio channel is allocated for management of the secondary information tag, it is possible to simplify the process relating to program-associated data broadcasting using the secondary information tag, and to improve efficiency.

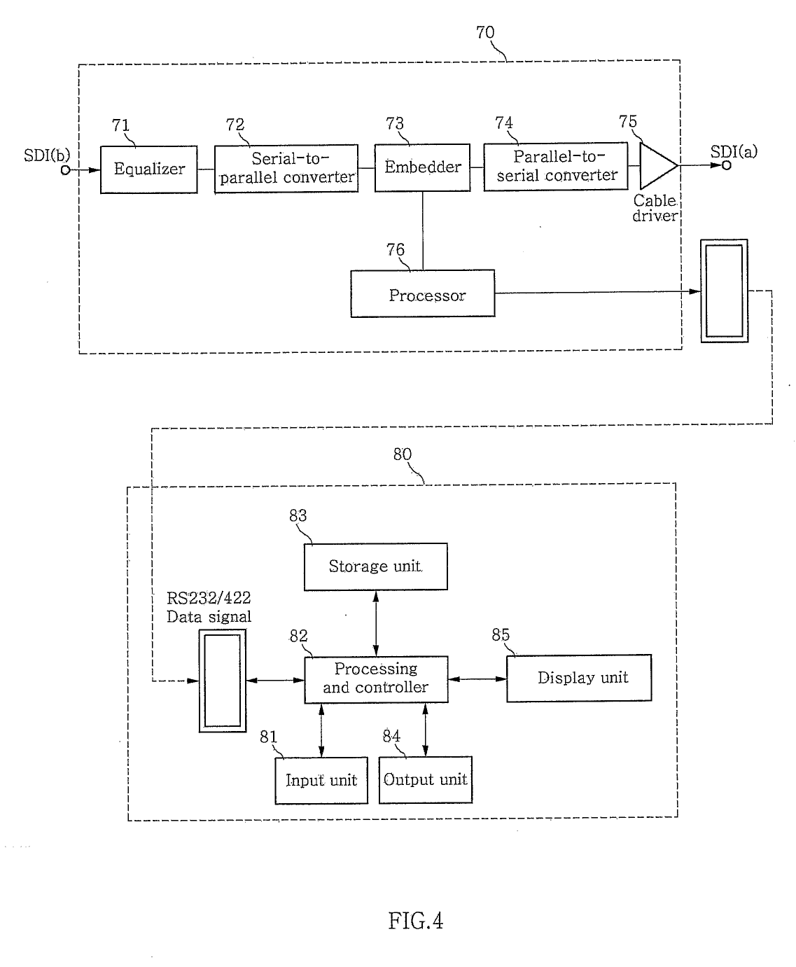

FIG. 4 is a block diagram illustrating the constructions of the secondary information tag extractor 70 and the secondary information tag processing unit 80 according to the present invention. Referring to FIG. 4, the secondary information tag extractor 70 includes an equalizer 71, a serial-to-parallel converter 72, a de-embedder 73, a parallel-to-serial converter 74, a cable driver 75 and a processor 76. The secondary information tag extractor 70 according to the present invention separates the secondary information tag, which has been embedded in the ancillary data area of the serial digital signals SDI(b), i.e. the AES3 signals, and converts the AES3 signals into text data, which are similar to data before being inputted to the secondary information tag input unit 10, according to an inverse algorithm of the SMPTE 337M.

The secondary information tag processing unit 80 includes an input unit 81, a processing and controller 82, a storage unit 83, an output unit 84 and a display unit 85. The secondary information tag processing unit 80 converts the text-based secondary information tag, which is received from the secondary information tag extractor 70 or inputted through the input unit 81, into data broadcasting contents, and transmits the data broadcasting contents to the storage unit 83 and/or the data broadcasting contents database 100. If the situation requires, the secondary information tag processing unit 80 may call a specific tag from the storage unit 83 and send the specific tag to the data broadcasting database 100. The input unit 81 in the secondary information tag processing unit 80 receives or modifies the content, which has been omitted in the production step or which is to be modified in the transmission step, according to the items of the secondary information tag as illustrated in FIG. 2.

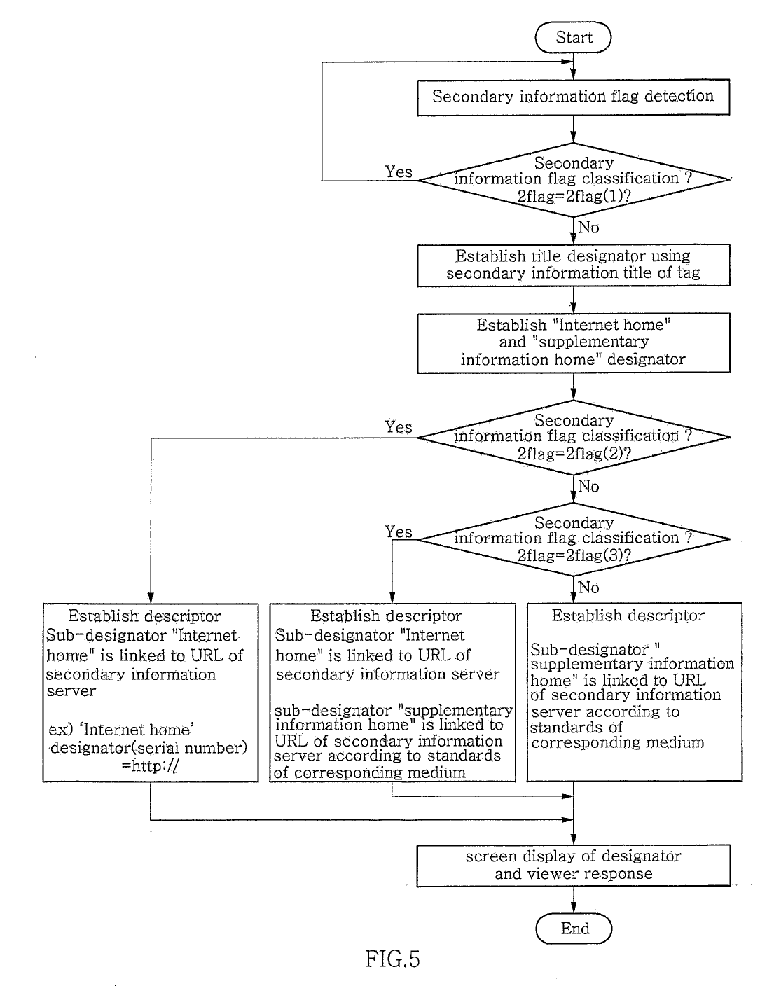

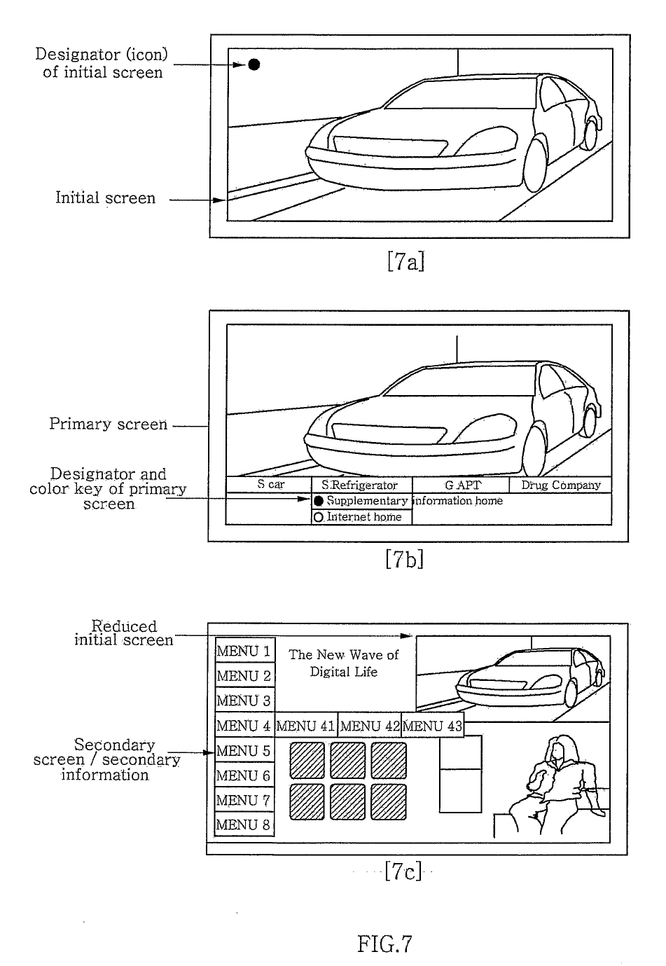

FIG. 5 is a flow diagram illustrating a procedure and a process in which the secondary information tag processing unit 80 processes the secondary information tag into the data broadcasting contents. The conversion from the text-based secondary information tag to the data broadcasting contents includes not only establishing a designator (an icon symbolized for selection) of the secondary information title as illustrated in FIG. 7b and displaying an auxiliary selection icon (“supplementary information home” and “Internet home”) on a screen when the designator is selected, but also describing a series of operations and a processing procedure, which are executed by an application program, by means of a programming language (JAVA, HTML, XML, APIs, etc.) based on data broadcasting standards according to broadcasting media.

According to the preferred embodiment of the present invention, four types of descriptor contents of the designator may exist according to the classification of the secondary information flag as shown in table 6.

TABLE 6
<Descriptor contents of designator (selection)
according to secondary information flag>

| Secondary | |
|---|---|
| information flag | Descriptor contents |
| 2flag(1) | Only designator of secondary |
| | information title is established, and |
| | serial number follows. Sub-designator |
| | and URL for search do not exist. |
| 2flag(2) | Designator of secondary information |
| | title is established so that |
| | designator “Internet home” in FIG. 7 |
| | is displayed as sub-designator. When |
| | sub-designator “Internet home” is |
| | selected, URL (http:// . . . ) is searched |
| | using Internet homepage address |
| | included in secondary information tag. |
| 2flag(3) | Designator of secondary information |
| | title is established so that |
| | designators “supplementary information |
| | home” and “Internet home” in FIG. 7 |
| | are displayed as sub-designators. |
| | When designator “supplementary |
| | information home” is selected, URL |
| | (acap:// . . . , ocap:// . . . , mhp:// . . . or |
| | gem:// . . . ) is searched based on data |
| | broadcasting standards. When |
| | designator “Internet home” is |
| | selected, corresponding URL (http:// . . . ) |
| | is searched. |
| 2flag(4) | Designator of secondary information |
| | title is established so that |
| | designator “supplementary information |
| | home” in FIG. 7 is displayed as sub- |
| | designator. When sub-designator |
| | “supplementary information home” is |
| | selected, URL (acap:// . . . , ocap:// . . . , |
| | mhp:// . . . or gem:// . . . ) is searched using |
| | supplementary information homepage |
| | address included in secondary |
| | information tag. |

FIGS. 7b and 7c are diagrams illustrating secondary information displayed on a monitor after data broadcasting is called according to one preferred embodiment of the present invention. In the receiver screen, a descriptor is described in such a manner that the designator (selection) of the secondary information title may be translucently superimposed on the lower portion of the screen in a horizontal direction as illustrated in FIG. 7b, and a sub-designator (“supplementary information home” and “Internet home”) may be superimposed under the title in a vertical direction when the designator is selected. When the sub-icon “Internet home” is selected, a URL (http:// . . . ) is searched using an Internet homepage address included in the secondary information tag. When the sub-icon “supplementary information home” is selected, a URL (acap:// . . . , ocap:// . . . , mhp:// . . . or gem:// . . . ) is searched based on data broadcasting standards.

The receiver screen is displayed in the form of a Picture in Picture (PIP) as illustrated in FIG. 7C. That is, it is common that a realtime broadcasting screen is disposed in an upper right corner of a quadrant on a reduced scale, and secondary information content is disposed in an “L” shape. However, a tertiary screen displayed when a secondary screen or a menu on the secondary screen is selected may also display only the content of the secondary information server on an entire screen. It is preferred that a screen construction method, a menu movement, a search end, etc., is implemented by buttons “RED”, “GREEN”, “YELLOW” and “BLUE”.

Table 7 shows the items of data to be stored in the storage unit 83 of the secondary information tag processing unit 80.

TABLE 7
<Configuration of items storage unit in secondary
information tag processing unit>

| Item name | Description |
|---|---|
| 2flag | secondary information flag |
| 2title | secondary information representative name |
| i_addr | Internet homepage address (http) in |
| | secondary information server URL |
| d_addr | supplementary information homepage address |
| | in secondary information server URL |
| Code | secondary information serial number |
| Selection_m | secondary information title designator |
| | (selection) |
| Selection_si | sub-designator “Internet home” |
| Selection_sd | sub-designator “supplementary information |
| | home” |
| Script_m | Descriptor for secondary information title |
| | designator |
| Script_si | Descriptor for sub-designator “Internet |
| | home” |
| Script_sd | Descriptor for sub-designator “supplementary |
| | information home” |

The data carried from the secondary information tag extractor 70 are processed in realtime, and sent to the data broadcasting database 100. The data inputted to the secondary information tag processing unit 80 or the data called from the storage unit 83 are sent to the data broadcasting database 100 through a separate operation.

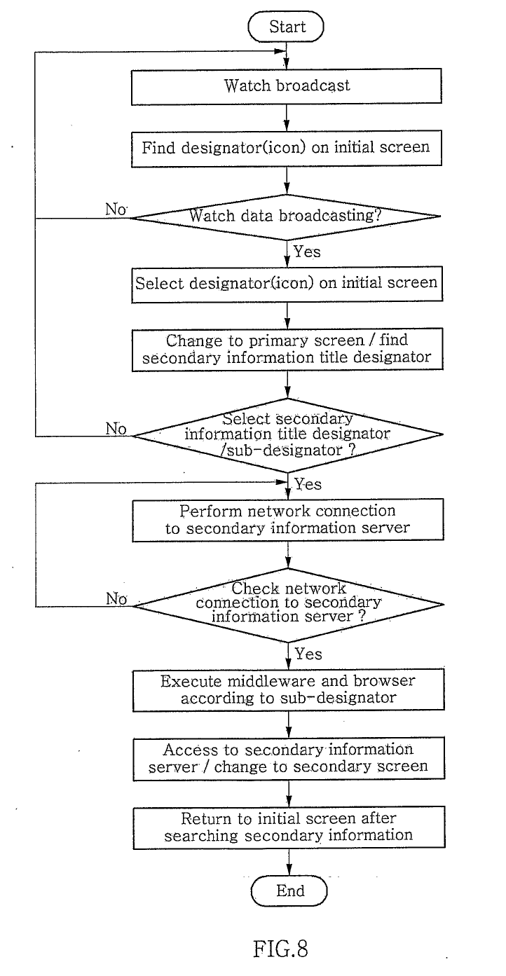

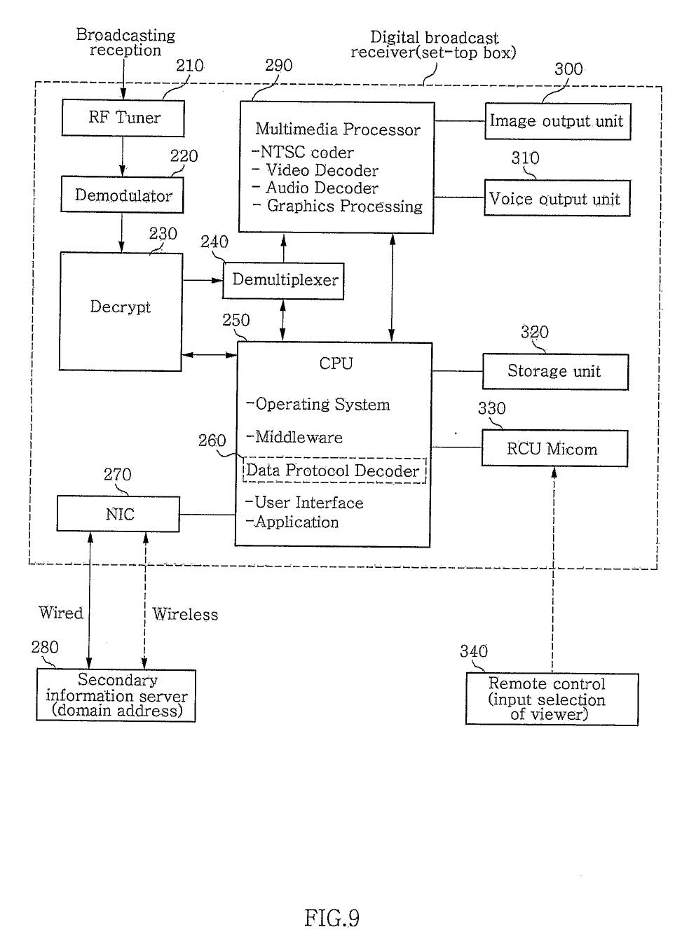

FIG. 8 is a flow diagram illustrating a process in which a viewer watching a broadcast finds a designator on an initial screen, implements a network connection to the secondary information server, and searches for detailed information according to the present invention. Referring to FIG. 9, if digital broadcasting is received, a digital broadcast receiver, i.e. a set-top box, decodes existence of program-associated data through a data protocol decoder 260. In this case, the digital broadcast receiver displays existence of the secondary information by means of the designator (icon) on the initial screen through a multimedia processor 290 and an image output unit 300 as illustrated in FIG. 7a. Then, the viewer watching the initial screen through the image output unit 300 requests the secondary information by using a remote control 340, and a central processing unit 250 of the receiver executes an application program including a corresponding browser, etc., and calls a secondary information server 280 through a network interface card 270. Data streams sent from the secondary information server 280 are displayed on a secondary screen through the image output unit 300 via data broadcasting middleware 260, as illustrated in FIG. 7c.

A digital broadcast receiver includes a set-top box, which is a dedicated broadcast receiver, and a computer equipped with a TV reception card. In the case of the set-top box and the computer, a desired secondary information title is selected. A set-top box user selects a sub-designator “supplementary information home”, and a computer user selects a sub-designator “Internet home”, thereby operating corresponding middleware and a search browser stored in the receiver.

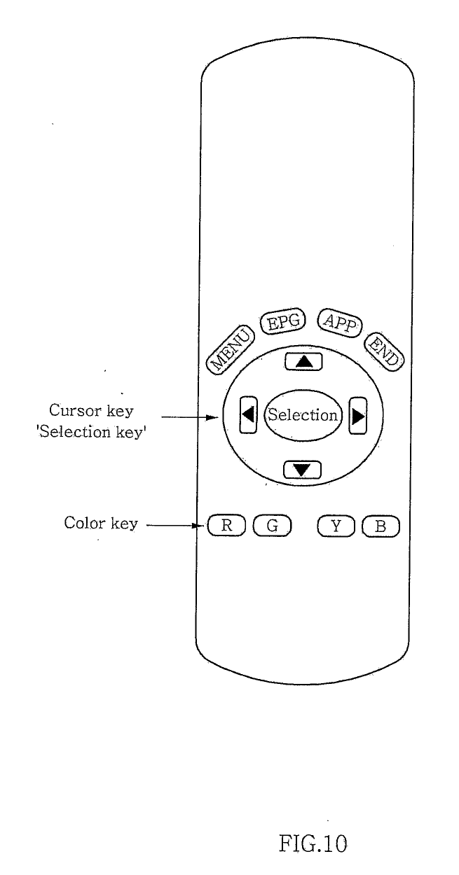

Calling of data broadcasting, and movement, selection and performance of a designator are controlled by a controller and a remote control included in a general receiver as illustrated in FIG. 10.

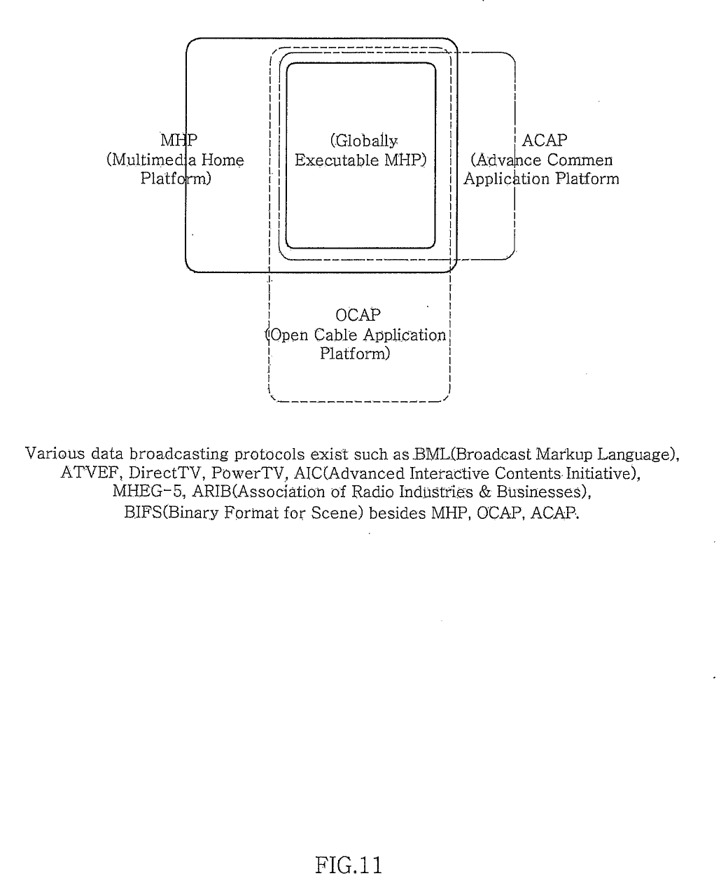

FIG. 11 is a diagram illustrating correlation between a Digital Video Broadcasting-Multimedia Home Platform (DVB-MHP) and several data broadcasting protocols similar to the DVB-MHP. In FIG. 11, a Globally Executable MHP (GEM) is a portion of the MHP, which is commonly prescribed to OpenCable Application Platform (OCAP) and Advanced Common Application Platform (ACAP) protocols and is compatible.

Various data broadcasting protocols exist according to countries or media, and a plurality of new standards may be provided in the future. The idea of the present invention lies in a method for extending data broadcasting to an Internet area, and corresponding protocols are not limited to specific standards.

In the above description, characteristics and technical advantages of the present invention are widely provided so that the claims of the present invention to be described below can be easily understood. Additional characteristics and advantages of the present invention will be described in detail in the following dependent claims. It must be recognized to those skilled in the art that the concept and specific embodiments of the present invention can be readily used for a design with a different structure or a modification for performing objects similar to those of the present invention.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

### INDUSTRIAL APPLICABILITY

As described above, the present invention provides an interactive advertisement in digital broadcasting environments, thereby increasing the advertisement effect. That is, the current broadcasting advertisement corresponds to a one-time advertisement in which one advertisement is provided to a viewer during about 20 seconds. In order for a viewer to obtain detailed information, it is possible to search the Internet or other media.

In a case in which an interactive advertisement is implemented through the present invention, secondary information is searched for through a receiver (a remote control) when a specific advertisement is broadcasted, so that various contents of the advertisement can be searched for. It is possible to search an Internet homepage or a supplementary information homepage separately provided according to a data broadcasting standard. In the case of an advertisement for a vehicle, it is possible to search information for the specifications, interior, appearance, cost, etc., of the vehicle. Further, it is also possible to implement electronic commerce.

Further, according to the present invention, it is possible to extend the information area of program-associated data broadcasting. That is, the present invention is useful when detailed information for specific content broadcasted by a broadcaster is exchanged. In the case of introducing food, it is possible to additionally receive information for a corresponding restaurant. Also in the case of documentaries, historical plays or sports broadcasting, a broadcasting producer provides viewers with an address of a secondary information server, etc., so that the viewers can search desired contents while continuously watching a broadcast.

Furthermore, according to the present invention, it is possible to efficiently manage the production process of program-associated data broadcasting and an advertisement service. That is, a production space of a broadcaster and a transmission space for transmission are typically separated. In order to transmit the program-associated data broadcasting, a program producer must join authoring and transmission of data broadcasting for synchronization of a program and the data broadcasting. According to the present invention, a program producer can complete such a work by inserting a secondary information tag into an associated location of the data broadcasting in the production step. Specifically, in the case of an advertisement, an advertisement producer or an advertisement agency can complete work necessary for program-associated data broadcasting by inserting a secondary information tag into advertisement material. Accordingly, it is possible to efficiently conduct necessary tasks.

1. A method for extending program-associated data broadcasting to an Internet area in digital broadcasting environments providing digital broadcasting, thereby providing interactive information, the method comprising the steps of:
(a) converting a secondary information tag, which is used for calling secondary information relating to data broadcasting, into data broadcasting contents according to data broadcasting protocols;
(b) inserting the secondary information tag converted in step (a) into a data broadcasting area of a digital broadcasting stream;
(c) transmitting the digital broadcasting stream including the secondary information tag, thereby allowing the digital broadcasting stream to be received in a digital broadcast receiver or a personal computer; and
(d) when a request for the secondary information is received from the digital broadcast receiver or the personal computer, transmitting the secondary information from a secondary information server to the digital broadcast receiver or the personal computer connected to a communication network.

2. The method as claimed in claim 1, wherein the digital broadcasting includes at least one of terrestrial digital broadcasting, satellite digital broadcasting, cable TV digital broadcasting, terrestrial mobile multimedia broadcasting and satellite mobile multimedia broadcasting.

3. The method as claimed in claim 1, wherein the secondary information tag is inserted into a Horizontal Ancillary (HANC) data area or a Vertical Ancillary (VANC) data area of serial digital signals in a production step before the digital broadcasting stream is transmitted.

4. The method as claimed in claim 1, wherein the secondary information tag includes at least one of a secondary information flag for reporting existence or absence of the secondary information, a secondary information title, an Internet homepage address of the secondary information server, an supplementary information homepage address of the secondary information server, and a serial number.

5. The method as claimed in claim 3, wherein the secondary information tag is inserted into one of multiple audio channels, the production step comprises the sub-steps of:
(e) converting the secondary information tag according to a serial digital audio signal standard; and
(f) embedding the secondary information tag converted according to the serial digital audio signal standard into the ancillary data area of the serial digital signals.

6. The method as claimed in claim 5, wherein the secondary information tag coded in step (a) is extracted from the ancillary data area of the serial digital signals.

7. The method as claimed in claim 1, wherein, in step (C), the digital broadcasting stream including the secondary information tag is remultiplexed into a digital broadcasting video stream and a digital broadcasting audio stream for transmission.

8. The method as claimed in claim 1, wherein, in step (a), when data broadcasting is called while a digital broadcasting or the digital broadcasting including the secondary information tag is displayed on an initial screen in the digital broadcast receiver or the personal computer, the secondary information tag inserted into the data broadcasting area of the data broadcasting stream is decoded, a secondary information title designator representing a secondary information title is displayed on the initial screen, an “Internet home” designator and/or “supplementary information home” designator, which are sub-designators of the secondary information title designator, are displayed under the secondary information title designator, access to the secondary information server and the secondary information is implemented through a communication network relating to an address of the secondary information when the request for the secondary information is received from the digital broadcast receiver or the personal computer, and the accessed content is displayed on a secondary screen or a tertiary screen.

9. The method as claimed in claim 8, wherein the designators displayed together with the initial screen correspond to the secondary information title designator, the “Internet home” designator and/or the “supplementary information home” designator, is defined by a secondary information title selection descriptor (script_m), a descriptor (script_si) for an access to a secondary information related Internet homepage address, and a descriptor (script_sd) for an access to a secondary information-related supplementary information homepage address, and includes at least one of the three descriptors.
